(19) United States
(12) Patent Application Publication
(10) Pub. No.: US 2011/0097954 A1
(43) Pub. Date: Apr. 28, 2011

(54) Peelable Coating

(75) Inventors: Christopher Peter Bone, Tallai (AU); Alois Helbling, Hope Island (AU)

(73) Assignee: Skudo Manufacturing Pty Ltd, Robina (AU)

(21) Appl. No.: 12/754,582

(22) Filed: Apr. 5, 2010

(30) Foreign Application Priority Data
Oct. 23, 2009 (AU) 2009905155

(51) Int. Cl. B32B 5/02; B32B 7/12; B32B 37/12; E04F 13/073; C09J 175/04; B32B 27/00; C09J 133/08

(52) U.S. Cl. 442/1; 428/352; 156/60; 156/71; 156/331.7; 156/332; 156/334

(57) ABSTRACT

A peelable coating for a surface substrate, and a method of applying same, is disclosed. The peelable coating can comprise a base layer that is releasably peelably applied atop the surface substrate; a reinforcement layer located atop the base layer; and a bond layer applied atop the reinforcement layer for bonding through the reinforcement layer to the base layer.

### FIELD OF THE INVENTION

The present invention relates to coatings and in particular to peelable coating.

The invention has been developed primarily for use as a peelable coating for protecting a floor substrate and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known peelable coating systems include a release coating applied to the floor surface and a durable coating applied to the release coating. This requires the durable coating being directly applied to the release coating.

### OBJECT OF THE INVENTION

It is an object of the present invention to overcome or ameliorate at least one of the disadvantages of the prior art, or to provide a useful alternative.

It is an object of the invention in its preferred form to provide a peelable coating, and method of application, that can be used on a variety of floor substrates.

### SUMMARY OF THE INVENTION

According to a first aspect of the invention there is provided a peelable coating comprising:
a base layer releasably peelably applied atop a surface substrate;
a reinforcement layer located atop the base layer; and
a bond layer applied atop the reinforcement layer for bonding through the reinforcement layer to the base layer.

According to a second aspect of the invention there is provided a method of applying a peelable coating comprising:
applying a releasably peelable base layer atop a surface substrate;
locating a reinforcement layer atop the base layer; and
applying a bond layer atop the reinforcement layer for bonding through the reinforcement layer to the base layer.

Preferably the base layer releasably adheres to the surface substrate. More preferably, the bond layer bonds the reinforcement layer to the base layer with a stronger bond than between the base layer and surface substrate, such that the peelable coating is peelable from the surface substrate. Most preferably, the surface substrate is a flooring substrate.

Preferably the base layer is allowed to dry before the reinforcement layer is located atop the base layer.

The base layer preferably comprises any one or more selected from the set including: natural latex, pre-vulcanised natural latex, high solids styrene-butadiene latex.

The reinforcement layer preferably comprises any one or more selected from the set including: a fibreglass mesh or a bio-degradable composition mesh.

The bond layer preferably comprises any one or more selected from the set including: pure acrylic, styrene acrylic, carboxylated styrene butadiene, polyurethane dispersions.

### BRIEF DESCRIPTION OF THE DRAWINGS

A preferred embodiment of the invention will now be described, by way of example only, with reference to the accompanying drawings in which:

FIG. 1 is a sectional side view of a peelable coating according to the invention; and

FIG. 2 is an example flowchart for a method of applying a peelable coating according to the invention.

### PREFERRED EMBODIMENT OF THE INVENTION

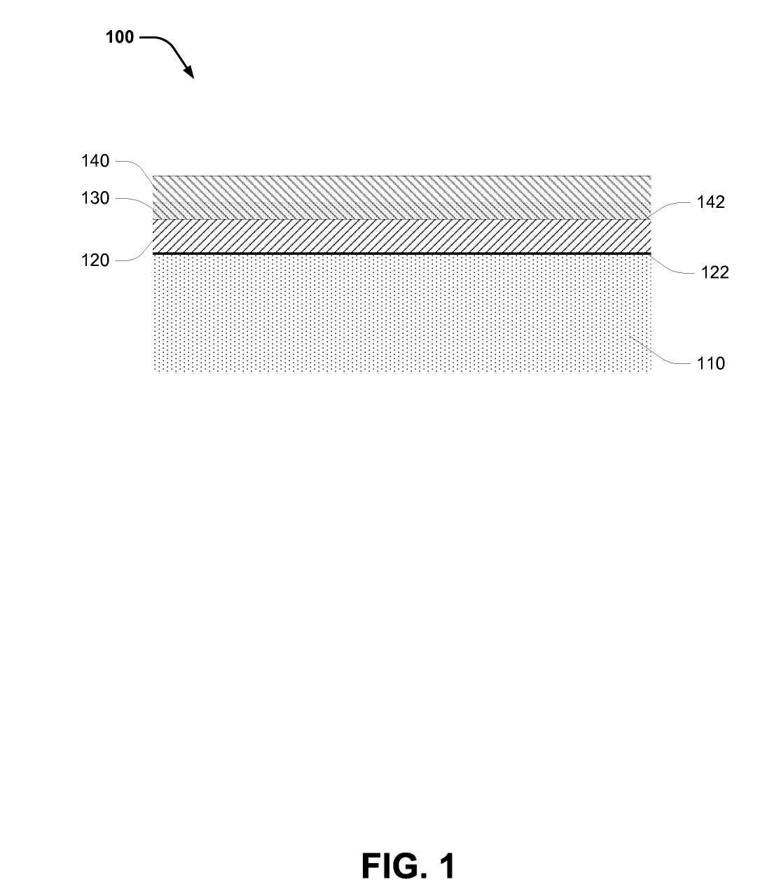

Referring initially to FIG. 1 of the drawings, in an example embodiment, a peelable coating 100 applied atop a surface substrate 110 comprises a base layer 120 that is releasably peelably applied atop a surface substrate, a reinforcement layer 130 located atop the base layer, and a bond layer 140 applied atop the reinforcement layer for bonding through the reinforcement layer to the base layer.

It will be appreciated that the surface substrate 110 is typically sealed prior to application of the peelable coating 100. The sealer will be appropriate to the material of the surface substrate. In some surface substrates, for example raw concrete or vinyl, no sealing may be required.

In this embodiment the base layer releasably adheres to a surface substrate at 122 in the form of a flooring surface substrate. The bond layer bonds, along with the reinforcement layer 130, to the base layer at 142 with a stronger bond than between the base layer and surface substrate. This enables the peelable coating to be peeled from the surface substrate as required.

In an embodiment, by way of example only, the base layer 120 can selected from a set comprising: natural latex, pre-vulcanised natural latex, high solids styrene-butadiene latex. It will be appreciated that the base layer can further comprise a blend of two or more of these materials.

One or more additives may further be included in the base layer. These additives can, by way of example, include: stabilising surfactants (either non-ionic or anionic), thickeners (either non-associative or associative), antifoaming agents, biocides, antioxidants, fillers (such as CaCO3), crumb rubber, microspheres, colour pigments, polyacrylate or polyphosphate dispersants.

In an embodiment, by way of example only, the reinforcement layer 130 is typically a mesh of either a fibreglass blend or a bio-degradable composition.

In an embodiment, by way of example only, the bond layer 140 can selected from a set comprising: pure acrylic, styrene acrylic, carboxylated styrene butadiene, polyurethane dispersions. It will be appreciated that the bond layer can further comprise a blend of two or more of these materials.

One or more additives may further be included in the bond layer. These additives can, by way of example, include: silica sand, fillers (such as CaCO3), microspheres, biocides, antifoaming agents, TiO2, alumina trihydrate, polyacrylate dispersants, polyphosphate dispersants, thickeners (either non-associative or associative) or colour pigments.

Styrene-butadiene or styrene-butadiene-rubber (SBR) is a synthetic rubber copolymer consisting of styrene and butadiene, and has suitable abrasion resistance. Styrene-butadiene can also be blended with natural rubber. Styrene butadiene rubber latex is a kind of high-polymer dispersion emulsion aggregated by butadiene and styrene. Carboxylated styrene butadiene rubber latex is also a kind of high-polymer dispersion emulsion aggregated by butadiene and styrene. This product has good inter-miscibility to padding, large volume of filling, strong viscidity, little foam, and solid coating.

An aqueous polyurethane (PU) dispersion is a binary colloidal system in which the polyurethane particles are dispersed in a continuous aqueous medium. Polyurethane dispersion have an advantage that the viscosity of dispersion is typically independent of the molecular weight of the polymer. Therefore, the polyurethane dispersion can be prepared at relatively high solid content with the molecular weight high enough to form a deposited film with suitable performance through physical drying (even at ambient temperatures).

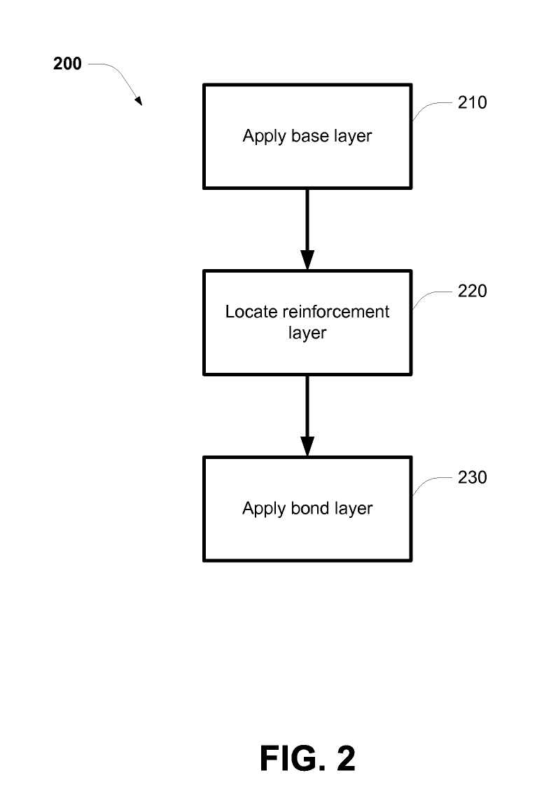

FIG. 2 shows an example flowchart 200 for a method of applying a peelable coating as previously described. This method of applying a peelable coating comprises:
Step 210, applying releasably peelable base layer atop a surface substrate;
Step 220, locating a reinforcement layer atop the base layer; and
Step 230, applying bond layer atop the reinforcement layer for bonding the reinforcement layer to the base layer.

In an example embodiment, a peelable coating 100 is a water based two coat system that is reinforced with a fiberglass mesh. Alternatively, a bio-degradable composition mess can be uses to reinforce the peelable coating. This coating provides a temporary peelable film for protecting a floor substrate from damage during a construction stage, and is suitable for both residential and commercial applications. The peelable coating can provide a non-slip impervious film when applied to the substrate, such that it does not slide and restricts foreign materials (including liquids) from coming into contact with the substrate. The peelable coating can withstand relatively heavy traffic, sunlight, rain or water, scuffing and is resistant to impact damage. It will be appreciated that the peelable coating, when applied to green concrete, can assist in curing concrete by retaining moisture.

Suitable substrates for receiving the peelable coating can include:
Concrete—sealed, polished or raw;
Tiles—granite, porcelain, marble etc;
Sealed timber floors;
Stainless steel;
Painted steel;
Glass;
Fiberglass;
Bench Tops; and
Selected Linoleum products.

In an embodiment, applying the peelable coating to a substrate can include the steps of:
a) ensuring the substrate is sealed, dry, clean and free of contaminates;
b) taping the perimeter of area to be coated with a UV stable adhesive tape;
c) applying a base layer (or coat) with either a brush, roller or airless spray gun, and finishing over half of the perimeter tape;
d) allowing the base layer to dry sufficiently;
e) laying out (or locating) fiberglass mesh (or bio-degradable mesh) onto the base layer, finishing up to the border tape, and ensuring that each run of mesh is over lapping the last run;
f) applying a bond layer with a brush or roller, and finishing over half of the border tape without coming into contact with the substrate, such that the bond layer is sufficiently thick to ensure it embeds into the mesh in an even coat;
g) allowing the bond layer to dry for a minimum of 12-24 hours prior to receiving traffic.

In this example embodiment, the base layer material is a hybrid blend of both pre-vulcanized natural rubber latex and an styrene-butadiene-rubber copolymer latex. This material has approximately 65-75% solids, a pH level of between 9.0-10.5, a viscosity between 6,000-8,000 mpa·s. This material is water based and non-hazardous. In an alternative embodiment, the base layer may comprise a single material.

In this example, the reinforcement mesh layer is either a fiberglass blend or a bio-degradable composition, having a weight of approximately 145-160 gsm, and a square size of about 5 mm-6.5 mm.

In this example, the base layer material is a blend of waterborne acrylic/styrenated acrylics and carboxylated styrene/butadiene copolymers. This material has approximately 55-65% solids, a pH level between 7.8-8.5, a viscosity between 4,000 mpa·s-5,500 mpa·s. This material is also water based and non-hazardous. It will be appreciated that the viscosity of the base layer material can include a greater range from 5 mpa·s through 8000 mpa·s.

In an embodiment, by way of example only, a peelable coating can include:
Silica sand applied to the top coat (or bond layer) to provide anti-slip surface;
Biocides as an in-can preservation, to provide mould and fungi resistance to the coating;
TiO2 in the top coat (or bond layer) to provide protection from UV radiation and free radical attack; and
Thickeners to provide rheology control for application and coating thickness.

In this embodiment, a peelable coating can optionally include any one or more of the following:
CaCO3 and/or Microspheres as an extender, for providing a cost reduction, increased solids content, faster drying rates and a higher film build;
Dispersants to aids filler dispersion by imparting an electrical charge to the filler particles' surface;
Alumina tri hydrate to impart ignition resistance for the coating; and
Colour pigments to visual aid application of the layers.

Silica sand can be added to the bond layer to provide an anti-slip surface on the peelable coating.

Thickeners can be used to provide rheology control over film/coating thickness and for aiding in application.

CaCO3 and microspheres are typically used as an extender for any one or more of the following:
reducing cost of the peelable coating;
increasing solids content;
providing faster drying rates; and
building a higher film/coating.

If fillers (for example CaCO3 and microspheres) are used, dispersants are typically added to aid filler dispersion by imparting an electrical charge to the particle's surface.

Biocides are provided for in-can preservation and protecting a dry film/coating from mould and fungi.

TiO2 provides protection from UV radiation and free radical attack, which is typically applied to the bond layer (or top coat).

Alumina tri hydrate can be added to either of the layers for providing ignition resistance, if required.

Colour pigments may be added to either of the layers for providing a visual aid during application.

It will be appreciated that the illustrated peelable coating, and method of application, can be used on a variety of floor substrates. Although the invention has been described with reference to specific examples, it will be appreciated by those skilled in the art that the invention may be embodied in many other forms.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” “down” and “atop”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

We claim:

1. A peelable coating for a surface substrate, the peelable coating comprising:
a base layer releasably peelably applied atop the surface substrate;
a reinforcement layer located atop the base layer; and
a bond layer applied atop the reinforcement layer for bonding through the reinforcement layer to the base layer.

2. The peelable coating according to claim 1, wherein the base layer releasably adheres to the surface substrate.

3. The peelable coating according to claim 1, wherein the bond layer bonds the reinforcement layer to the base layer with a stronger bond than between the base layer and the surface substrate, such that the peelable coating is peelable from the surface substrate.

4. The peelable coating according to claim 1, wherein the surface substrate is a flooring substrate.

5. The peelable coating according to claim 1, wherein the base layer is allowed to dry before the reinforcement layer is located atop the base layer.

6. The peelable coating according to claim 1, wherein the base layer comprises any one or more selected from the set including:
natural latex,
pre-vulcanised natural latex, and
high solids styrene-butadiene latex.

7. The peelable coating according to claim 1, wherein the reinforcement layer comprises any one or more selected from the set including:
a fibreglass mesh, and
a bio-degradable composition mesh.

8. The peelable coating according to claim 1, wherein the bond layer comprises any one or more selected from the set including:
pure acrylic,
styrene acrylic,
carboxylated styrene butadiene, and
polyurethane dispersions.

9. A peelable coating for a surface substrate, the peelable coating comprising:
a base layer releasably peelably applied atop the surface substrate;
a reinforcement layer located atop the base layer;
a bond layer applied atop the reinforcement layer for bonding through the reinforcement layer to the base layer;
wherein the base layer releasably adheres to the surface substrate; and
wherein the bond layer bonds the reinforcement layer to the base layer with a stronger bond than between the base layer and surface substrate, such that the peelable coating is peelable from the surface substrate.

10. The peelable coating according to claim 9, wherein the base layer is allowed to dry before the reinforcement layer is located atop the base layer.

11. A method of applying a peelable coating comprising:
applying a releasably peelable base layer atop a surface substrate;
locating a reinforcement layer atop the base layer; and
applying a bond layer atop the reinforcement layer for bonding through the reinforcement layer to the base layer.

12. The method according to claim 11, wherein the base layer releasably adheres to the surface substrate.

13. The method according to claim 11, wherein the bond layer bonds the reinforcement layer to the base layer with a stronger bond than between the base layer and the surface substrate, such that the peelable coating is peelable from the surface substrate.

14. The method according to claim 11, wherein the surface substrate is a flooring substrate.

15. The method according to claim 11, wherein the base layer is allowed to dry before the reinforcement layer is located atop the base layer.

16. The method according to claim 11, wherein the base layer comprises any one or more selected from the set including:
natural latex,
pre-vulcanised natural latex, and
high solids styrene-butadiene latex.

17. The method according to claim 11, wherein the reinforcement layer comprises any one or more selected from the set including:
a fibreglass mesh, and
a bio-degradable composition mesh.

18. The method according to claim 11, wherein the bond layer comprises any one or more selected from the set including:
pure acrylic,
styrene acrylic,
carboxylated styrene butadiene, and
polyurethane dispersions.
